(19) United States
(12) Patent Application Publication
(10) Pub. No.: US 2011/0315849 A1
(43) Pub. Date: Dec. 29, 2011

(54) DRILL BRACING DEVICE

(76) Inventor: HAN TENTY, Portland, OR (US)

(21) Appl. No.: 12/822,154

(22) Filed: Jun. 23, 2010

(51) Int. Cl. F16M 13/02

(52) U.S. Cl. 248/646

(57) ABSTRACT

A drill bracing device comprising a set of tracks, including a first track and a second track, with a front portion and a back portion, to fit over a bridge wall, and a press attached to the first track, where the press includes a handle, a mobile grip, and a stationary grip mounted on the second track. The drill bracing device also comprises a stationary brace secured against the back portion of the set of tracks and against a back side of the bridge wall, an adjustment brace adjustably secured against the front portion of the set of tracks and against a front side of the bridge wall wherein the handle turns the mobile grip of the press to tighten a drill between the mobile grip and the stationary grip. The drill bracing device secures the drill in against the bridge wall to maintain stability and alignment while drilling.

### BACKGROUND OF THE INVENTION

1. Field of the Invention

The present invention relates to a brace to secure a drill in place while doing construction on a bridge.

2. Description of Related Art

Conventional bridge drilling methods require the use of expensive lifts, and a significant amount of pressure to maintain stability and alignment. In the midst of moving traffic and trains, safe and accurate drilling may be difficult while on a snorkel lift, scaffolding or boom lift due to unintended drill resistance. Many times the bridge or the street below must be closed from passing traffic so that the workers may move in the large lifts and other heavy equipment. A major problem while using a drill on or against a bridge rail, a worket must maintain the correct location for drilling, which is exhausting and sometimes dangerous. The worker must continuously hold up the drill, draining strength from their arms and bodies, while applying enough pressure against the rail to actually penetrate the concrete. Once the drill does drives through the concrete, the drill may hit a section of rebar, thus creating another dangerous element. The metal rebar causes the drill to jump or kickback which is potentially very dangerous to the worker, because the kickback may cause a shift in their position or cause the worker to completely drop the drill.

It would be desirable in the art to have a tool to hold the drill in place while working on a bridge. It would also be beneficial that the tool be able to withstand enough pressure to avoid the kickback in case rebar is hit.

### SUMMARY OF THE INVENTION

The present invention provides a means to prevent injuries while performing drill work on bridges. A drill bracing device according to the present invention allows a construction worker to safely operate a large drill without the danger of shifting, dropping or losing control of the drill. The drill bracing device holds the drill between a set of U-shaped tracks positioned over the bridge wall. The drill is held in a press attached to the tracks, wherein the press applies enough pressure against the drill and the wall for secure drilling. As the drill is used, the worker worries less about hitting rebar, because the drill bracing device will withstand the kickback associated when a drill hits metal. Once the specified drill is centered between the tracks and powered on, the construction worker may better maintain control and increase their ability to manipulate the object being drilled, thus reducing the likelihood of falls or hazards.

Another object of the present invention is that the drill bracing device may be easily repositioned from one location to another along the bridge wall. This enables the worker to handily switch locations increasing the efficiency and output of their work performed.

Another object of the present invention is that the device will save money for the construction project because fewer drill bits will need to be replaced, since fewer bits will break against the rebar, and the heavy lifts will not be required.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 is a perspective view of a drill bracing device in accordance with an exemplary embodiment of the present invention;

FIG. 2 is a side view of a drill bracing device with a drill in accordance with an exemplary embodiment of the present invention; and

FIG. 3 is a side view of a drill bracing device with a press in accordance with an exemplary embodiment of the present invention.

Like reference numerals refer to like parts throughout the description of several views of the drawings.

### DETAILED DESCRIPTION OF THE DRAWINGS

The primary object of the present invention is to provide a drill bracing device to be used with a drill while working on a bridge wall or rail. The drill bracing device may be a manually operated two track system that allows a user to easily use a large drill while working on a bridge. The drill bracing device may hold the drill in a press between a set of parallel tracks positioned over the bridge wall. The press may apply enough pressure on the drill so that while in use the drill does not shift, jump or kickback. The drill bracing device may allow a construction worker to safely operate a large drill while tearing through concrete and even steel along the bridge. The construction worker may focus on their task at hand rather than continuously worry when the drill may kickback against a piece of reinforcement bar. With greater peace of mind, the job may be completed faster and more efficiently, thus saving the construction crew time and money.

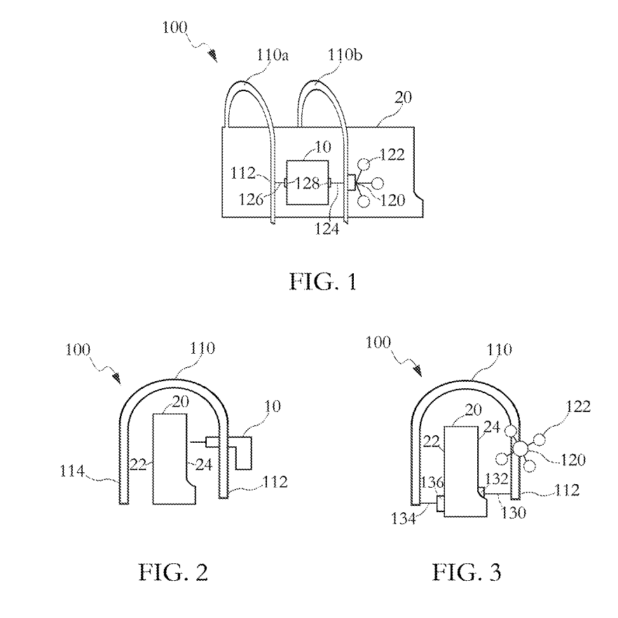

Turning to the drawings, referring to FIG. 1, a perspective view of a drill bracing device (100) is shown in accordance with an exemplary embodiment of the present invention. The drill bracing device (100) may comprise a set of tracks (110a and 110b) (hereinafter tracks) and a press (120). The tracks (110a and 110b) include a front portion (112) and a back portion (114) (shown in FIG. 2), and may be an inverted U-shape over a bridge wall (20). A drill (10) fits between the tracks (110a and 110b) of the drill bracing device (100). The press (120) is positioned along the front portion (112) of the track (110b). The press (120) comprises a handle (122) with a plurality of posts, a mobile grip (124) and a stationary grip (126). The plurality of posts on the handle (122) rotate to apply torque to the press (120), thus moving the mobile grip (124) horizontally towards the drill (10). The press (120) includes a screw to enable the movement of the mobile grip (124). The stationary grip (126) extends from the track (110a). The stationary grip (126) remains stationary while the mobile grip (124) moves horizontally. The drill (10) abuts a pair of press pads (128) at the end of the mobile grip (124) and the stationary grip (126). A user may rotate the handle (122) to secure the drill (10) between the pair of press pads (128) by tightening the mobile grip (124).

The press (120) moves vertically along the tracks (110a and 110b) depending on where the drill (10) needs to be placed. The drill bracing device (100) may be tightened and adjusted to brace the drill (10) between the tracks (110a and 110b). Next, a user may move the drill (10) towards the bridge wall (20) for drilling. Once the drill (10) is in place, the drill bracing device (100) ensures that the drill (10) does not slip or jump when drilling into the bridge wall (20). The drill bracing device (100) may allow a construction worker to safely work on the side of the bridge without worrying about the drill (10) falling or losing their grip.

Referring to FIG. 2, a side view of the drill bracing device (100) is shown with the drill (10) in accordance with an exemplary embodiment of the present invention. The bridge wall (20) is shown with a front side (24) and a back side (22). The front portion (112) of the track (110) is positioned along the front side (24) of the bridge wall (20). The back portion (114) of the track (110) is positioned along the back side (22) of the bridge wall (20). The drill bracing device (100) is capable of holding the drill (10) at a specific location along the front side (24) of the bridge wall (20).

Referring to FIG. 3, a side view of the drill bracing device (100) is shown with the press (120) in accordance with an exemplary embodiment of the present invention. The press (120) may be on the front portion (112) of the track (110) along the front side (24) of the bridge wall (20). The back portion (114) of the track (110) includes a stationary brace (134) with a stationary brace pad (136). The stationary brace (134) and the stationary brace pad (136) secures the back portion (114) of the drill bracing device (100) against the back side (22) of the bridge wall (20). The front portion (112) of the track (110) includes an adjustable brace (130) and a mobile brace pad (132). The adjustable brace (130) with the mobile brace pad (132) may adjustably tighten against the front side (24) of the bridge wall (20) to hold the drill bracing device (100) in place. The stationary brace (134) and the adjustable brace (130) work in tandem to secure the drill bracing device (100) against the bridge wall (20).

The drill bracing device according to the present invention allows a construction worker to safely operate a large drill while working on the wall or rail of a bridge. The drills used may include a roto hammer, rebar cutter, core drill, masonry drill or another drill commonly used in the art. The tracks may be positioned around 18 inches apart to accommodate the various types of drills used. The drill bracing device may assist the construction worker to apply enough pressure to drill through a concrete barrier and even a portion of reinforced bar. Once the specified drill is centered between the two tracks and powered on, the construction worker may better maintain control and increase their ability to manipulate the object being drilled, thus reducing the likelihood of falls or hazards.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A drill bracing device for securing and using a drill on a bridge wall comprising:
a set of tracks, including a first track and a second track, with a front portion and a back portion, to fit over a bridge wall;
a press attached to the first track, where the press includes a handle, a mobile grip, and a stationary grip mounted on the second track;
a stationary brace secured against the back portion of the set of tracks and against a back side of the bridge wall; and
an adjustable brace secured against the front portion of the set of tracks and against a front side of the bridge wall wherein as the handle turns on the press, the mobile grip moves towards the stationary grip to tightly hold a drill between the mobile grip and the stationary grip.

2. The drill bracing device of claim 1, wherein the press exerts a significant amount of pressure against the drill to stabilize the drill while drilling.

3. The drill bracing device of claim 1, wherein the mobile grip includes a press pad, at a location between where the mobile grip pushes against the drill.

4. The drill bracing device of claim 1, wherein the stationary grip includes a press pad, at a location between where the stationary grip pushes against the drill.

5. The drill bracing device of claim 1, wherein the press raises and lowers along the set of tracks.

6. The drill bracing device of claim 1, wherein the adjustment brace contains a mobile brace pad.

7. The drill bracing device of claim 1, wherein the stationary brace contains a stationary brace pad.
